(19) United States
(12) Patent Application Publication
(10) Pub. No.: US 2025/0372786 A1
(43) Pub. Date: Dec. 4, 2025

(54) ENERGY STORAGE SYSTEM INCLUDING AN INTEGRATED STRUCTURAL SUBCOMPONENT

(71) Applicant: Fluence Energy, LLC, Arlington, VA (US)

(72) Inventors: Kathryn Corine Streng Callahan, Golden, CO (US); Jordan David Petrie, Neenah, WI (US)

(73) Assignee: Fluence Energy, LLC, Arlington, VA (US)

(21) Appl. No.: 19/221,870

(22) Filed: May 29, 2025

Related U.S. Application Data
(60) Provisional application No. 63/654,603, filed on May 31, 2024.

(51) Int. Cl. H01M 50/242; H01M 10/613; H01M 10/6556; H01M 50/204; H01M 50/238; H01M 50/244

(52) U.S. Cl. CPC H01M 50/242; H01M 10/613; H01M 10/6556; H01M 50/238; H01M 50/244; H01M 50/204

(57) ABSTRACT

An energy storage enclosure including a battery pack, a plurality of battery modules arranged within the battery pack, a plurality of battery submodules arranged within each of the battery modules, and a plurality of battery cells arranged within each of the plurality of battery submodules. Each of the battery submodules includes a structural subcomponent having a first structural plate, a second structural plate, a first structural end plate fixedly attached to the first structural plate and the second structural plate, and a second structural end plate fixedly attached to the first structural plate and the second structural plate.

### CROSS REFERENCE TO RELATED APPLICATION

This application claims the benefit of, and right of priority to, U.S. Provisional Patent Application No. 63/654,603, filed May 31, 2024, and entitled “ENERGY STORAGE SYSTEM INCLUDING AN INTEGRATED STRUCTURAL SUBCOMPONENT,” the contents of which are expressly incorporated by reference as if fully set herein.

### INTRODUCTION

The concepts described herein relate generally to energy storage systems, and more specifically, to modular energy storage systems including battery modules having an integrated structural subcomponent.

Modular energy storage systems include multiple individual energy storage enclosures interconnected to provide varied levels of storage capacity. Energy storage systems can be used to store additional power produced by an external power source during periods of reduced demand and provide additional power to external power sources during periods of increased demand.

Each energy storage enclosure includes multiple battery modules containing multiple battery submodules. Each battery submodule includes multiple individual battery cells/cell stacks arranged adjacent to one another. That is, multiple individual battery cells/cell stacks are assembled adjacent to one another and with many other components to provide the structure and stiffness required within the battery module.

As such, it would be advantageous to provide a battery module with integrated structural support that increases the structural stiffness to the battery module, while decreasing component complexity and assembly time.

### SUMMARY

In view of the above discussion, it is useful to develop an energy storage system including a battery module that combines multiple individual battery module building block components, for example but not limited to, end plates, side plates, cold plates, into a single integrated structural subcomponent, which would maintain the structure and stiffness needed within the battery module, while eliminating the need for steel strapping to support cell expansion loads, reducing both component complexity and battery module assembly time.

The concepts disclosed herein relate to an energy storage system that includes battery modules having trays with integrated cell expansion supports fixedly attached to an inside surface of each tray. The integrated cell expansion supports provide structural support, in the form of structural stiffness, for the battery module, and for cell expansion.

An energy storage enclosure according to the present disclosure may include a battery pack, a plurality of battery modules arranged within the battery pack, and a plurality of battery submodules arranged within each of the plurality of battery modules.

A plurality of battery cells may be arranged within each of the plurality of battery submodules. Each of the battery submodules may include a structural subcomponent having a first structural plate, a second structural plate, a first structural end plate fixedly attached to the first structural plate and the second structural plate, a second structural end plate fixedly attached to the first structural plate and the second structural plate.

According to one aspect of the disclosure, the first structural plate may include a structural top plate, and the second structural plate may include a structural bottom plate.

The structural top plate may include a first end portion that is fixedly attached at a top portion of the first structural end plate, and a second end portion that is fixedly attached at a top portion of the second structural end plate.

The structural bottom plate may include a first end portion that is fixedly attached at a bottom portion of the first structural end plate, and a second end portion that is fixedly attached at a bottom portion of the second structural end plate.

According to one aspect of the disclosure, at least one of the structural top plate and the structural bottom plate may include a cold plate.

According to one aspect of the disclosure, the first structural plate may be a first structural side plate, and the second structural plate may be a second structural side plate.

The first structural side plate may include a first end portion and a second end portion. The first end portion may be fixedly attached at a first side portion of the first structural end plate. The second end portion may be fixedly attached at a first side portion of the second structural end plate.

The second structural plate may include a first end portion and a second portion. The first portion may be fixedly attached at a second side portion of the first structural end plate. The second end portion may be fixedly attached at a second side portion of the second structural end plate.

According to one aspect of the disclosure, the plurality of battery cells/cell stacks may be arranged within the structural subcomponent that may be arranged within each of the plurality of battery submodules.

According to another aspect of the disclosure, a modular energy storage system may include at least two energy storage enclosures coupled to one another, a power conversion module element coupled to an external power source and the at least two energy storage enclosures.

Each of the at least two energy storage enclosures may include a battery pack, a plurality of battery modules arranged within the battery pack, a plurality of battery submodules arranged within each of the battery modules, and a plurality of battery cells arranged within each of the plurality of battery submodules.

Each of the battery submodules may include a structural subcomponent having a first structural plate, a second structural plate, a first structural end plate fixedly attached to the first structural plate and the second structural plate, and a second structural end plate fixedly attached to the first structural plate and the second structural plate.

According to one aspect of the disclosure, the first structural plate may include a structural top plate, and the second structural plate may include a structural bottom plate.

The structural top plate may include a first end portion that is fixedly attached at a top portion of the first structural end plate, and a second end portion that is fixedly attached at a top portion of the second structural end plate.

The structural bottom plate may include a first end portion that is fixedly attached at a bottom portion of the first structural end plate, and a second end portion that is fixedly attached at a bottom portion of the second structural end plate.

According to one aspect of the disclosure, at least one of the structural top plate and the structural bottom plate may include a cold plate.

According to one aspect of the disclosure, the first structural plate may be a first structural side plate, and the second structural plate may be a second structural side plate.

The first structural side plate may include a first end portion and a second end portion. The first end portion may be fixedly attached at a first side portion of the first structural end plate. The second end portion may be fixedly attached at a first side portion of the second structural end plate.

The second structural plate may include a first end portion and a second portion. The first portion may be fixedly attached at a second side portion of the first structural end plate. The second end portion may be fixedly attached at a second side portion of the second structural end plate.

A battery module for an energy storage enclosure is also disclosed. The battery module may include a plurality of battery submodules arranged within the battery module.

A plurality of battery cells may be arranged within the plurality of battery submodules. Each of the battery submodules may include a structural subcomponent having a first structural plate, a second structural plate, a first structural end plate fixedly attached to the first structural plate and the second structural plate, a second structural end plate fixedly attached to the first structural plate and the second structural plate.

According to one aspect of the disclosure, the first structural plate may include a structural top plate, and the second structural plate may include a structural bottom plate.

The structural top plate may include a first end portion that is fixedly attached at a top portion of the first structural end plate, and a second end portion that is fixedly attached at a top portion of the second structural end plate.

The structural bottom plate may include a first end portion that is fixedly attached at a bottom portion of the first structural end plate, and a second end portion that is fixedly attached at a bottom portion of the second structural end plate.

According to one aspect of the disclosure, at least one of the structural top plate and the structural bottom plate may include a cold plate.

According to one aspect of the disclosure, the first structural plate may be a first structural side plate, and the second structural plate may be a second structural side plate.

The first structural side plate may include a first end portion and a second end portion. The first end portion may be fixedly attached at a first side portion of the first structural end plate. The second end portion may be fixedly attached at a first side portion of the second structural end plate.

The second structural plate may include a first end portion and a second portion. The first portion may be fixedly attached at a second side portion of the first structural end plate. The second end portion may be fixedly attached at a second side portion of the second structural end plate.

According to one aspect of the disclosure, the plurality of battery cells/cell stacks may be arranged within the structural subcomponent that may be arranged within each of the plurality of battery submodules.

By providing a battery module with an integrated structural subcomponent, multiple individual battery module building block components are integrated into a single integrated structural subcomponent, eliminating the need for steel strapping to support cell expansion loads, while maintaining the structure and stiffness needed within the battery module, and reducing both component complexity and battery module assembly time.

The above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

The accompanying drawings, which are incorporated into and constitute a part of this specification, illustrate implementations of the disclosure which, taken together with the description, serve to explain the principles of the disclosure.

FIG. 1 schematically illustrates an energy storage system including a plurality of energy storage enclosures, in accordance with the disclosure.

FIG. 2 schematically illustrates an energy storage enclosure including a battery pack, in accordance with the disclosure.

FIG. 3 schematically illustrates an exploded view of a battery module in accordance with one aspect of the disclosure.

FIG. 4 schematically illustrates a cross-sectional front view of a battery module including a structural subcomponent, in accordance with one aspect of the disclosure.

The appended drawings are not necessarily to scale and may present a somewhat simplified representation of various preferred features of the present disclosure as disclosed herein, including, for example, specific dimensions, orientations, locations, and shapes. Details adjacent to such features will be determined in part by the particular intended application and use environment.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments may be practiced without some of these details. Moreover, for the purpose of clarity, certain technical material that is understood in the related art has not been described in detail in order to avoid unnecessarily obscuring the disclosure. Furthermore, the disclosure, as illustrated and described herein, may be practiced in the absence of an element that is not specifically disclosed herein.

The present disclosure is susceptible of embodiment in many different forms. Representative examples of the disclosure are shown in the drawings and described herein in detail as non-limiting examples of the disclosed principles. To that end, elements and limitations described herein, but not explicitly set forth in the claims, are not to be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, and the words “including,” “containing,” “comprising,” “having,” and the like shall mean “including without limitation.” Moreover, words of approximation such as “about,” “almost,” “substantially,” “generally,” “approximately,” etc., may be used herein in the sense of “at, near, or nearly at,” or “within 0-5% of,” or “within acceptable manufacturing tolerances,” or logical combinations thereof.

As used herein, the term “system” refers to mechanical and electrical hardware, software, firmware, electronic control componentry, processing logic, and/or processor device, individually or in combination, including without limitation: Application Specific Integrated Circuit(s) (ASIC), an electronic circuit, a processor (shared, dedicated, or group) that executes one or more software or firmware programs, memory device(s) that electrically store software or firmware instructions, a combinatorial logic circuit, and/or other components that provide the described functionality.

As employed herein, terms such as “vertical”, “horizontal”, “left”, “right”, “upper”, “lower”, “top”, “bottom” and similar expressions are non-limiting terms that merely describe the various elements as illustrated in the Figures and are not intended to limit the scope of the disclosure.

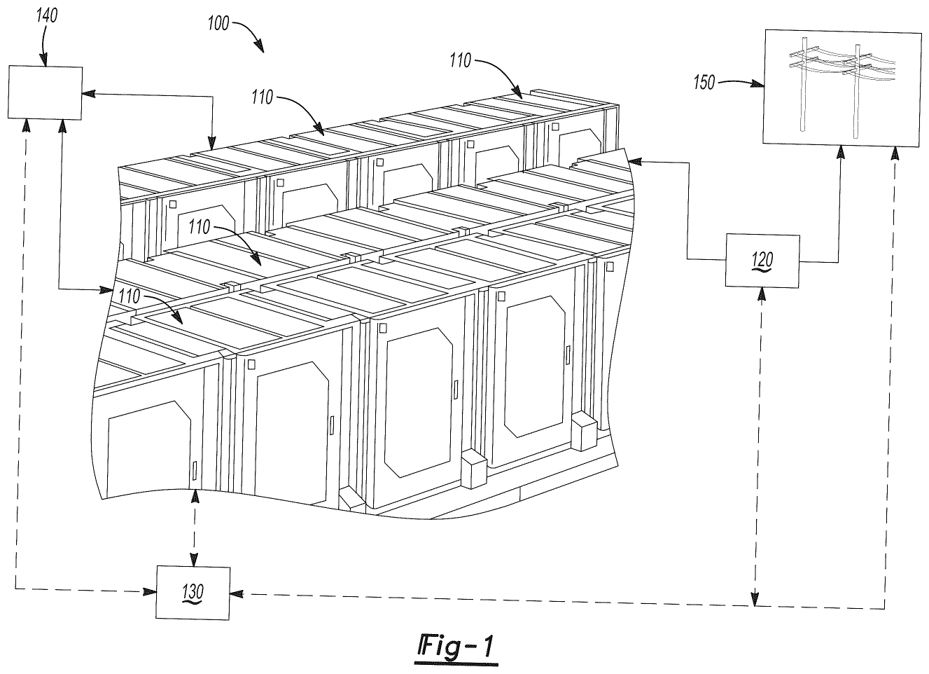

Referring to the drawings, wherein like reference numbers refer to the same or like components in the several Figures, FIG. 1 schematically illustrates an isometric view of an energy storage system 100 including a plurality of energy storage enclosures 110. The energy storage system 100 includes the plurality of energy storage enclosures 110, a power conversion module 120, a controller 130, an external cooling system 140, and an external power source 150.

The plurality of energy storage enclosures 110 are coupled to one another electrically, and collectively coupled to the power conversion module 120, the controller 130, the external cooling system 140, and the external power source 150. The plurality of energy storage enclosures 110, individually and collectively, are operable to store alternating current (AC) power delivered from the external power source 150 as direct current (DC) power, for example but not limited to when the demand for power from the external power source 150 is lower than the external power source 150 is operable to generate, and/or to provide DC power to the external power source 150, for example but not limited to, when the demand for power is higher than the external power source 150 is operable to generate. It should be appreciated that the plurality of energy storage enclosures 110 may be coupled to one another not only electrically, but also mechanically, and/or fluidly.

To facilitate the conversion of AC power to DC power and DC power to AC power, the power conversion module 120 is configured to standardize power input and output between the plurality of energy storage enclosures 110 and the external power source 150. The power conversion module 120 may include, for example but not limited to, a converter configured to convert AC power to DC power, and/or DC power to AC power.

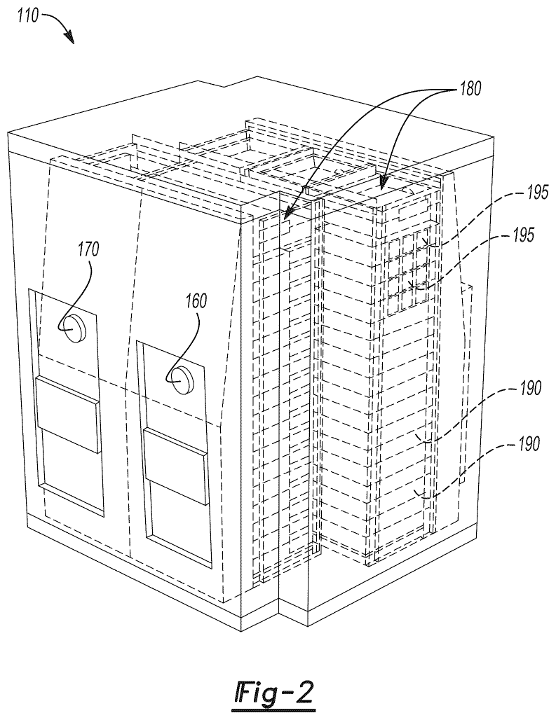

The external cooling system 140 is coupled to the plurality of energy storage enclosures 110, and the controller 130. The external cooling system is configured provide coolant at a first temperature T₁ to the plurality of energy storage enclosures 110 through at least one input port 160 and receive coolant from the plurality of energy storage units at a second temperature T₂ from at least output port 170 (FIG. 2), such that T₁ is lower than T₂.

The external cooling system 140 may include, for example but not limited to, a heat exchanging system having a pump, a condenser, a heat exchange, and a sump. It should be appreciated that the at least one input port 160 and the at least one output port 170 may include more than one input port 160 and/or one output port 170, and each of which may be arranged in one or more of the plurality of energy storage enclosures 110.

The external power source 150 is coupled to the plurality of energy storage enclosures 110. The external power source 150 is operable to provide AC power converted to DC power to the plurality of energy storage enclosures 110 to be stored as DC power, and to receive AC power converted from DC power from the plurality of energy storage enclosures 110, as discussed above.

The controller 130 is in communication with the plurality of energy storage enclosures 110, the power conversion module 120, the external cooling system 140, and the external power source 150, and is configured to control the aforementioned plurality of energy storage enclosures 110, the power conversion module 120, the external cooling system 140, and their communication with the external power source 150.

The term “controller” and related terms such as microcontroller, control module, module, control, control unit, processor and similar terms refer to one or various combinations of Application Specific Integrated Circuit(s) (ASIC), Field-Programmable Gate Array (FPGA), electronic circuit(s), central processing unit(s), e.g., microprocessor(s) and associated memory component(s) in the form of transitory and/or non-transitory memory component(s) and storage devices (read only, programmable read only, random access, hard drive, etc.). The non-transitory memory component is capable of storing machine readable instructions in the form of one or more software or firmware programs or routines, combinational logic circuit(s), input/output circuit(s) and devices, signal conditioning and buffer circuitry and other components that may be accessed by one or more processors to provide a described functionality. Input/output circuit(s) and devices include analog/digital inverters and related devices that monitor inputs from sensors, with such inputs monitored at a preset sampling frequency or in response to a triggering event. Software, firmware, programs, instructions, control routines, code, algorithms and similar terms mean controller-executable instruction sets including calibrations and look-up tables.

As schematically illustrated in FIG. 2, an energy storage enclosure 110 includes a battery pack 180, and a plurality of battery modules 190 arranged within the battery pack 180. Each of the plurality of battery modules 190 includes a plurality of battery submodules 195.

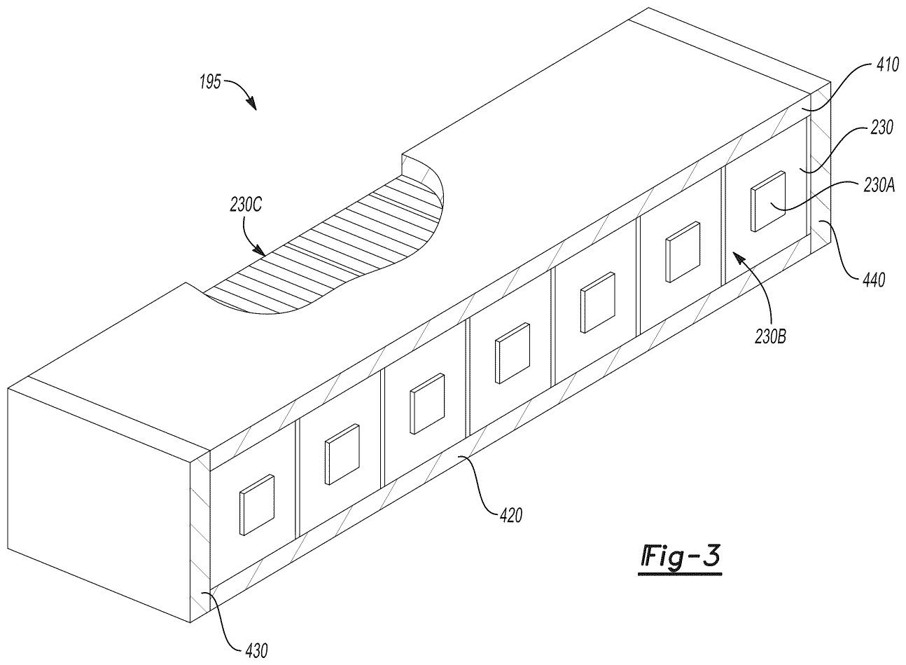

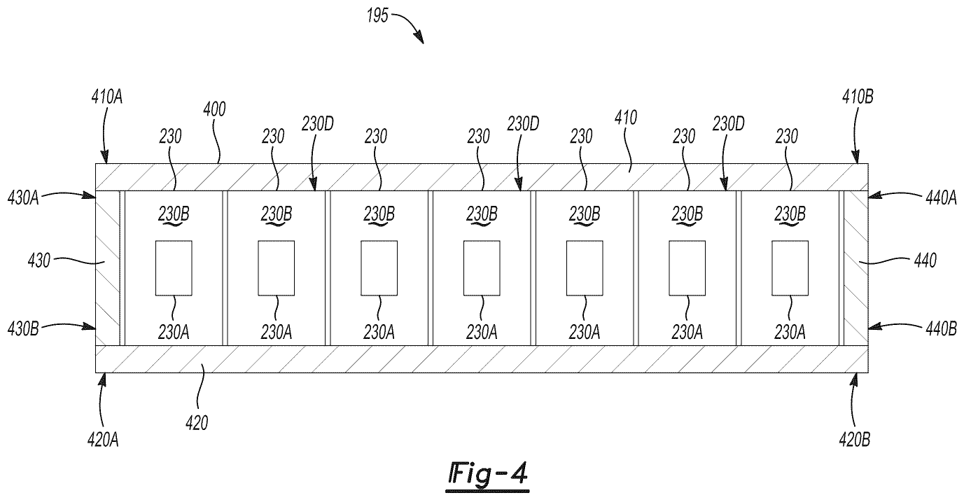

As schematically illustrated in FIG. 3, each of the plurality of battery submodules 195 includes a structural subcomponent 400 (FIG. 4.). A plurality of battery cells/cell stacks 230 are arranged within each of the plurality of battery submodules 195. Each of the battery submodules 195 modules include the structural subcomponent 400 having a first structural plate 410, a second structural plate 420, a first structural end plate 430 fixedly attached to the first structural plate 410 and the second structural plate 420, a second structural end plate 440 fixedly attached to the first structural plate 410 and the second structural plate 420. The first structural plate 410, the second structural plate 420, the first structural end plate 430, and the second structural end plate may be fixedly attached to one another by, for example but not limited to, welding, mechanical interlocking, and the like.

According to one aspect of the disclosure, the plurality of battery cells/cell stacks 230 are arranged within the structural subcomponent 400 that is arranged within each of the plurality of battery submodules 195.

A front view of a structural subcomponent 400 is schematically illustrated in FIG. 4. A plurality of battery cells/cell stacks 230 are arranged within the structural subcomponent 400 of each of the plurality of battery submodules 195.

Each of the battery submodules 195 modules include the structural subcomponent 400 having a first structural plate 410, a second structural plate 420, a first structural end plate 430 fixedly attached to the first structural plate 410 and the second structural plate 420, a second structural end plate 440 fixedly attached to the first structural plate 410 and the second structural plate 420. The first structural plate 410, the second structural plate 420, the first structural end plate 430, and the second structural end plate may be fixedly attached to one another by, for example but not limited to, welding, mechanical interlocking, and the like.

According to one aspect of the disclosure, the first structural plate 410 includes a structural top plate, and the second structural plate 420 includes a structural bottom plate. In this configuration, cell tabs 230A extend outward from opposing sides 230B, 230C (FIG. 3) of each of the plurality of battery cells/cell stack 230.

The structural top plate 410 includes a first end portion 410A that is fixedly attached at a top portion 430A of the first structural end plate 430, and a second end portion 410B that is fixedly attached at a top portion 440A of the second structural end plate 440.

The structural bottom plate 420 includes a first end portion 420A that is fixedly attached at a bottom portion 430B of the first structural end plate 430, and a second end portion 420B that is fixedly attached at a bottom portion 440B of the second structural end plate 440.

According to one aspect of the disclosure, at least one of the structural top plate 410 and the structural bottom plate 420 includes a cold plate.

It should be appreciated that the first structural plate 410 may include a first structural side plate, and the second structural plate 420 may include a second structural side plate. The first structural side plate 410 may include a first end portion 410A and a second end portion 410B. The first end portion 410A may be fixedly attached at a first side portion 430A of the first structural end plate 430. The second end portion 410B may be fixedly attached at a first side portion 440A of the second structural end plate 440. The second structural plate 420 may include a first end portion 420A and a second portion 420B. The first portion 420A may be fixedly attached at a second side portion 430B of the first structural end plate 430. The second end portion 420B may be fixedly attached at a second side portion 440B of the second structural end plate 440.

In this configuration, the cell tabs 230A would extend upward from a top surface 230D of each of the plurality of battery cells/cell stacks 230, as opposed to outward from opposing sides 230B, 230C, as illustrated in FIG. 4.

According to another aspect of the disclosure, a modular energy storage system 100 includes at least two energy storage enclosures 110 coupled to one another, a power conversion module 120 coupled to an external power source 150 and the at least two energy storage enclosures 110.

Each of the at least two energy storage enclosures 110 include a battery pack 180, a plurality of battery modules 190 arranged within the battery pack 180, a plurality of battery submodules 195 arranged within each of the battery modules 190, and a plurality of battery cells/cell stacks 230 arranged within each of the plurality of battery submodules 190.

Each of the battery submodules 190 includes a structural subcomponent 400 having a first structural plate 410, a second structural plate 420, a first structural end plate 430 fixedly attached to the first structural plate 410 and the second structural plate 420, and a second structural end plate 440 fixedly attached to the first structural plate 410 and the second structural plate 420. The first structural plate 410, the second structural plate 420, the first structural end plate 430, and the second structural end plate may be fixedly attached to one another by, for example but not limited to, welding, mechanical interlocking, and the like.

According to one aspect of the disclosure, the first structural plate 410 includes a structural top plate, and the second structural plate 420 includes a structural bottom plate. In this configuration, cell tabs 230A extend outward from opposing sides 230B, 230C (FIG. 3) of each of the plurality of battery cells/cell stack 230.

The structural top plate 410 includes a first end portion 410A that is fixedly attached at a top portion 430A of the first structural end plate 430, and a second end portion 410B that is fixedly attached at a top portion 440A of the second structural end plate 440.

The structural bottom plate 420 includes a first end portion 420A that is fixedly attached at a bottom portion 430B of the first structural end plate 430, and a second end portion 420B that is fixedly attached at a bottom portion 440B of the second structural end plate 440.

According to one aspect of the disclosure, at least one of the structural top plate 410 and the structural bottom plate 420 includes a cold plate.

It should be appreciated that the first structural plate 410 may include a first structural side plate, and the second structural plate 420 may include a second structural side plate as discussed above. In this configuration, the cell tabs 230A would extend upward from a top surface 230D of each of the plurality of battery cells/cell stacks 230, as opposed to outward from opposing sides 230B, 230C, as illustrated in FIG. 4.

According to another aspect of the disclosure, a battery module 190 for an energy storage enclosure 110 is disclosed. The battery module 190 includes a plurality of battery submodules 195.

Each of the plurality of battery submodules 195 includes a structural subcomponent 400 (FIG. 3). A plurality of battery cells/cell stacks 230 are arranged within each of the plurality of battery submodules 195. Each of the battery submodules 195 modules include the structural subcomponent 400 having a first structural plate 410, a second structural plate 420, a first structural end plate 430 fixedly attached to the first structural plate 410 and the second structural plate 420, a second structural end plate 440 fixedly attached to the first structural plate 410 and the second structural plate 420. The first structural plate 410, the second structural plate 420, the first structural end plate 430, and the second structural end plate may be fixedly attached to one another by, for example but not limited to, welding, mechanical interlocking, and the like.

According to one aspect of the disclosure, the plurality of battery cells/cell stacks 230 are arranged within the structural subcomponent 400 that is arranged within each of the plurality of battery submodules 195.

A plurality of battery cells/cell stacks 230 are arranged within the structural subcomponent 400 of each of the plurality of battery submodules 195 (FIG. 4).

Each of the battery submodules 195 modules include the structural subcomponent 400 having a first structural plate 410, a second structural plate 420, a first structural end plate 430 fixedly attached to the first structural plate 410 and the second structural plate 420, a second structural end plate 440 fixedly attached to the first structural plate 410 and the second structural plate 420. The first structural plate 410, the second structural plate 420, the first structural end plate 430, and the second structural end plate may be fixedly attached to one another by, for example but not limited to, welding, mechanical interlocking, and the like.

According to one aspect of the disclosure, the first structural plate 410 includes a structural top plate, and the second structural plate 420 includes a structural bottom plate. In this configuration, cell tabs 230A extend outward from opposing sides 230B, 230C (FIG. 3) of each of the plurality of battery cells/cell stack 230.

The structural top plate 410 includes a first end portion 410A that is fixedly attached at a top portion 430A of the first structural end plate 430, and a second end portion 410B that is fixedly attached at a top portion 440A of the second structural end plate 440.

The structural bottom plate 420 includes a first end portion 420A that is fixedly attached at a bottom portion 430B of the first structural end plate 430, and a second end portion 420B that is fixedly attached at a bottom portion 440B of the second structural end plate 440.

According to one aspect of the disclosure, at least one of the structural top plate 410 and the structural bottom plate 420 includes a cold plate.

It should be appreciated that the first structural plate 410 may include a first structural side plate, and the second structural plate 420 may include a second structural side plate, as discussed above. In this configuration, the cell tabs 230A would extend upward from a top surface 230D of each of the plurality of battery cells/cell stacks 230, as opposed to outward from opposing sides 230B, 230C, as illustrated in FIG. 4.

By providing a battery module with an integrated structural subcomponent, multiple individual battery module building block components are integrated into a single integrated structural subcomponent, eliminating the need for steel strapping to support cell expansion loads, while maintaining the structure and stiffness needed within the battery module, and reducing both component complexity and battery module assembly time.

These and other attendant benefits of the present disclosure will be appreciated by those skilled in the art in view of the foregoing disclosure.

The detailed description and the drawings or figures are supportive and descriptive of the present teachings, but the scope of the present teachings is defined solely by the claims. While some of the best modes and other examples for carrying out the present teachings have been described in detail, various alternative designs and aspects of the disclosure exist for practicing the present teachings defined in the appended claims.

What is claimed is:

1. An energy storage enclosure comprising:
a battery pack;
a plurality of battery modules arranged within the battery pack;
a plurality of battery submodules arranged within each of the battery modules; and
a plurality of battery cells arranged within each of the plurality of battery submodules, wherein each of the battery submodules includes a structural subcomponent having:
a first structural plate;
a second structural plate;
a first structural end plate fixedly attached to the first structural plate and the second structural plate; and
a second structural end plate fixedly attached to the first structural plate and the second structural plate.

2. The energy storage enclosure as recited in claim 1, wherein the first structural plate is a structural top plate, and the second structural plate is a structural bottom plate.

3. The energy storage enclosure as recited in claim 2, wherein the structural top plate includes:
a first end portion that is fixedly attached at a top portion of the first structural end plate, and a second end portion that is fixedly attached at a top portion of the second structural end plate; and
wherein the structural bottom plate includes:
a first end portion that is fixedly attached at a bottom portion of the first structural end plate, and a second end portion that is fixedly attached at a bottom portion of the second structural end plate.

4. The energy storage enclosure as recited in claim 3, wherein at least one of the structural top plate and the structural bottom plate includes a cold plate.

5. The energy storage enclosure as recited in claim 1, wherein the first structural plate is a first structural side plate, and the second structural plate is a second structural side plate.

6. The energy storage enclosure as recited in claim 5, wherein the first structural side plate includes:
a first end portion that is fixedly attached at a first side portion of the first structural end plate, and a second end portion that is fixedly attached at a first side portion of the second structural end plate; and
wherein the second structural plate includes:
a first end portion that is fixedly attached at a second side portion of the first structural end plate, and a second end portion that is fixedly attached at a second side portion of the second structural end plate.

7. The energy storage enclosure as recited in claim 1, wherein the plurality of battery cells are arranged within the structural subcomponent.

8. A modular energy storage system comprising:
at least two energy storage enclosures coupled to one another;
a power conversion module coupled to an external power source and the at least two energy storage enclosures, wherein each of the at least two energy storage enclosures includes:
a battery pack;
a plurality of battery modules arranged within the battery pack;
a plurality of battery submodules arranged within each of the battery modules; and
a plurality of battery cells arranged within each of the plurality of battery submodules, wherein each of the battery submodules includes a structural subcomponent having:
a first structural plate;
a second structural plate;
a first structural end plate fixedly attached to the first structural plate and the second structural plate; and
a second structural end plate fixedly attached to the first structural plate and the second structural plate.

9. The modular energy storage system as recited in claim 8, wherein the first structural plate is a structural top plate, and the second structural plate is a structural bottom plate.

10. The modular energy storage system as recited in claim 9, wherein the structural top plate includes:
a first end portion that is fixedly attached at a top portion of the first structural end plate, and a second end portion that is fixedly attached at a top portion of the second structural end plate; and
wherein the structural bottom plate includes:
a first end portion that is fixedly attached at a bottom portion of the first structural end plate, and a second end portion that is fixedly attached at a bottom portion of the second structural end plate.

11. The modular energy storage system as recited in claim 10, wherein at least one of the structural top plate and the structural bottom plate includes a cold plate.

12. The modular energy storage system as recited in claim 8, wherein the first structural plate is a first structural side plate, and the second structural plate is a second structural side plate.

13. The modular energy storage system as recited in claim 12, wherein the first structural side plate includes:
a first end portion that is fixedly attached at a first side portion of the first structural end plate, and a second end portion that is fixedly attached at a first side portion of the second structural end plate; and
wherein the second structural plate includes:
a first end portion that is fixedly attached at a second side portion of the first structural end plate, and a second end portion that is fixedly attached at a second side portion of the second structural end plate.

14. A battery module for an energy storage enclosure, the battery module comprising:
a plurality of battery submodules arranged within the battery module; and
a plurality of battery cells arranged within each of the plurality of battery submodules, wherein each of the battery submodules includes a structural subcomponent having:
a first structural plate;
a second structural plate;
a first structural end plate fixedly attached to the first structural plate and the second structural plate; and
a second structural end plate fixedly attached to the first structural plate and the second structural plate.

15. The battery module as recited in claim 14, wherein the first structural plate is a structural top plate, and the second structural plate is a structural bottom plate.

16. The battery module as recited in claim 15, wherein the structural top plate includes:
a first end portion that is fixedly attached at a top portion of the first structural end plate, and a second end portion that is fixedly attached at a top portion of the second structural end plate; and
wherein the structural bottom plate includes:
a first end portion that is fixedly attached at a bottom portion of the first structural end plate, and a second end portion that is fixedly attached at a bottom portion of the second structural end plate.

17. The battery module as recited in claim 16, wherein at least one of the structural top plate and the structural bottom plate includes a cold plate.

18. The battery module as recited in claim 14, wherein the first structural plate is a first structural side plate, and the second structural plate is a second structural side plate.

19. The battery module as recited in claim 18, wherein the first structural side plate includes:
a first end portion that is fixedly attached at a first side portion of the first structural end plate, and a second end portion that is fixedly attached at a first side portion of the second structural end plate; and
wherein the second structural plate includes:
a first end portion that is fixedly attached at a second side portion of the first structural end plate, and a second end portion that is fixedly attached at a second side portion of the second structural end plate.

20. The battery module as recited in claim 14, wherein the plurality of battery cells is arranged within the structural subcomponent.
